(19) United States
(12) Patent Application Publication
(10) Pub. No.: US 2024/0418012 A1
(43) Pub. Date: Dec. 19, 2024

(54) SECURING A TOILETRIES DISPENSING DEVICE

(71) Applicant: WE CAN DO THAT INCORPORATED DBA AQUAMENITIES, Concord, CA (US)

(72) Inventor: Kenneth Raymond Haworth, Walnut Creek, CA (US)

(73) Assignee: WE CAN DO THAT INCORPORATED DBA AQUAMENITIES, Concord, CA (US)

(21) Appl. No.: 18/209,381

(22) Filed: Jun. 13, 2023

(51) Int. Cl. E05B 65/00; A47K 5/12

(52) U.S. Cl. CPC E05B 65/006; A47K 5/1202; A47K 2005/1218

(57) ABSTRACT

A base including a bottom plate is configured for mounting to a surface, and a top plate. One or more dispensing bottles including flanged bottoms. The base top plate has one or more openings for the one or more dispensing bottles. The flanged bottoms have a diameter greater than the one or more openings of the base top plate, and the one or more openings has a releasable portion and a non-releasable portion. The releasable portion accommodates the one or more flanged bottoms to slide between the base bottom plate and the base top plate. A locking mechanism has a holding pin and a tumbler. The tumbler is accessible external to the base plate by a key to lock the one or more dispensing bottles into the base plate by rotating the tumbler to hold the releasable portion.

### FIELD OF THE INVENTION

The invention relates generally to a mechanical device, and more specifically, to a secured, toiletries dispensing device.

### BACKGROUND

Hotels and other commercial establishments have public bathrooms with many different visitors over time. Condiments, such as liquids, soaps and lotions are often provided along with paper towels, toilet paper and other necessities for the environment. These liquid condiments are refilled by janitors from a large volume supply.

Unfortunately, some visitors abuse condiments by intentionally stealing bottles, or even unintentionally mishandling bottles by moving them around and knocking them over. This can become costly as some hotels carry high end brands.

Some conventional mounted devices are permanently affixed. A top can be opened for refilling as needed. However, these commercial style containers can have a military issue look and feel that does not give a good guest experience.

What is needed is an improved technique for secured, toiletries dispensing device to prevent undesirable tampering.

### SUMMARY

To meet the above-described needs, methods, device and systems for secured toiled dispensaries are set forth.

In one embodiment, a base including a bottom plate is configured for mounting to a surface, and a top plate. One or more dispensing bottles including flanged bottoms. The base top plate has one or more openings for the one or more dispensing bottles. The flanged bottoms have a diameter greater than the one or more openings of the base top plate, and the one or more openings has a releasable portion and a non-releasable portion. The releasable portion accommodates the one or more flanged bottoms to slide between the base bottom plate and the base top plate.

In another embodiment, a locking mechanism has a holding pin and a tumbler. The tumbler is accessible external to the base plate by a key to lock the one or more dispensing bottles into the base plate by rotating the tumbler to hold the releasable portion.

Advantageously, toiletry bottles are easily secured while maintaining a user friendly experience.

### BRIEF DESCRIPTION OF THE DRAWINGS

In the following drawings, like reference numbers are used to refer to like elements. Although the following figures depict various examples of the invention, the invention is not limited to the examples depicted in the figures.

FIG. 1 is a perspective diagram illustrating a secured, toiletries dispensing device, according to an embodiment.

FIG. 2A is a perspective diagram illustrating views of a base of the toiletries dispensing device with a locking mechanism, according to an embodiment.

FIG. 2B is a perspective diagram illustrating a view of an alternative locking mechanism manufactured with a single weld, according to an embodiment.

FIG. 3 is a perspective diagram illustrating views of a dispensing bottle having a flanged bottom, according to an embodiment.

FIG. 4 is a high-level flow diagram illustrating a method for securing a toiletries dispensing device, according to an embodiment.

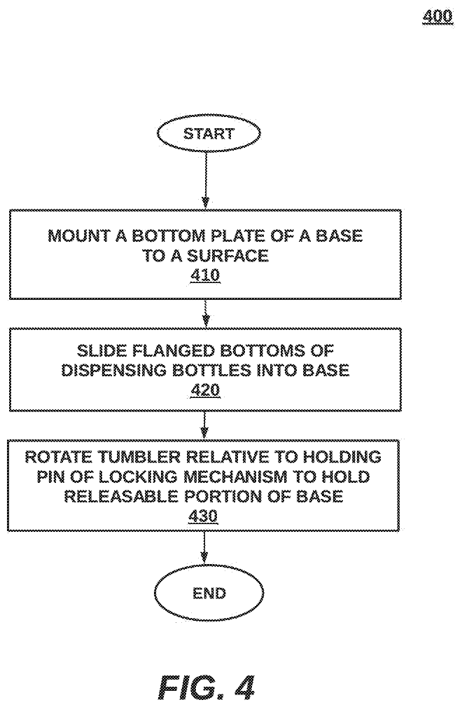

### DETAILED DESCRIPTION

Methods, computer program products, and devices for secured, toiletries dispensing. One of ordinary skill in the art will recognize numerous additional variations that are possible, given the concise disclosure herein.

### I. Device for Secured Toiletries Dispensing

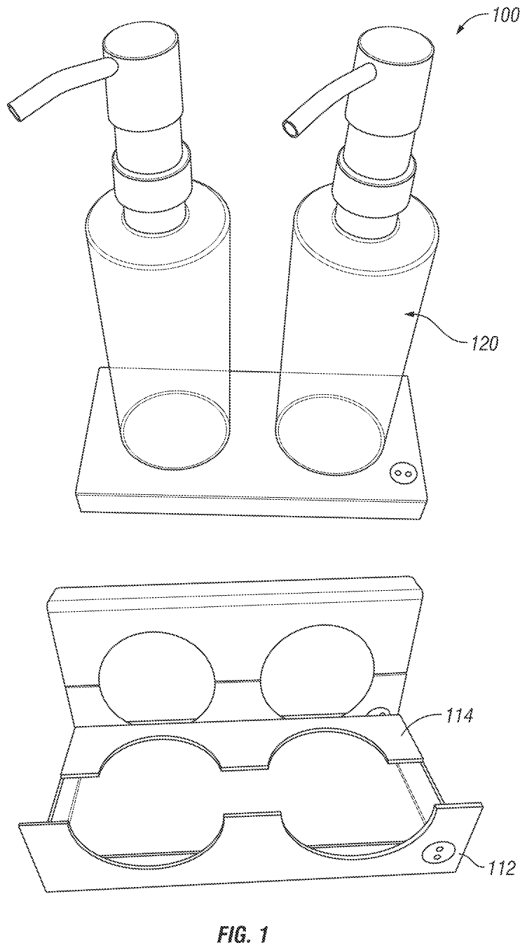

FIG. 1 is a perspective diagram illustrating a secured, toiletries dispensing device, according to an embodiment. The toiletries dispensing device 100 includes a base 110, dispensing bottles 120 and a locking mechanism 130. Many variations are possible, such as additional dispensing bottles and corresponding base openings. The toiletries dispensing device 100 can be mounted in any of a home, hotel, bathroom, kitchen, showroom, desktop, mobile home or other locations as needed. For example, a hotel guest can dispense a recognizable brand of hand washing gel in a bathroom, from a dispenser conveniently mounted next to a vanity faucet, without being able to take the product.

The base 110 can be mounted a countertop to provide a stable foundation. Depending on the implementation, mounting can be secured temporarily by Velcro or double-sided tape without damaging the countertop, or permanently by bolting. The surface can be a marble, Corian, granite or another appropriate material, oriented horizontal, vertical or at an angle. The base 110 can be composed of stainless steel, plastic, rubber, waterproof material, or any appropriate combination of materials.

A rectangular-shaped base 110 is shown in FIG. 1, with a bottom plate, a top plate and sidewalls. Components can be separate or cast together, such as the top plate and some sidewalls of FIG. 1. The bottom plate can be secured to the surface. The top plate has two openings to accommodate two dispensing bottles 120. The side walls are preferably a height that allows the dispensing bottles 120 to slide in between the top plate and the side plate in a secure and stable manner. The openings of the top plate are preferably sized for the width of dispensing bottles 120. In other embodiments, there can be one, three or a different number of openings that can also vary in size. Also, openings (and the base) can alternatively be circular, as shown, oval, square, rectangular or any appropriate shape to match dispensing bottle 120.

In one embodiment, the top plate has a releasable portion 112 and a non-releasable portion 114. The releasable portion can have a hinge allowing the releasable portion to rotate to an open position so that dispensing bottles can slide inside the base. Once completed, the releasable portion 112 can return to a closed position. A different embodiment includes a spring-loaded sliding mechanism for expanding the openings. Many other variations are possible, such as two-sides that release rather than a single front.

The dispensing bottle 120 can hold, for example, liquid soaps, lotions or shampoo when deployed in a bathroom setting. Other environments may store dish detergent, bubble bath, hand sanitizer, cleaners, cooking oils, beverages, paints, or other supplies. The dispensing bottle cavity has a cylindrical shape with a pump screw in top. The pump can have a tube reaching deep into that cylinder towards a bottom. When a user depresses a head of the pump, a suction is generated to pull liquid up the tube and release through the head. Branding labels and stickers can be placed on the bottle cylinders or elsewhere for distinctiveness. In some cases, manufacturers deliver bottles filled with liquid products and in other cases standard bottles are filled and modified with labels for branding.

The bottoms are flanged to a diameter greater than the one or more openings of the base top plate. It is the flanged portion 124 that slides into the base and is closed in by the releasable portion 112 of the top plate. As a result, when a user dispenses toiletries or other liquids, the resulting force is counteracted by the base to hold the dispensing bottle 120 in place. Once locked, the flanged portion 124 prevents removal of the dispensing bottle 120 due to counterforce from the top plate. The flanged portion 124 can be integral to a cylinder 122 or a cylinder can be modified to include a flanged portion.

Further, a locking mechanism 130 prevents the releasable portion 112 of the top plate for opening without a key. This prevents theft, disorganization, and other undesirable actions. The locking mechanism 130 has a holding pin 132 attached to the non-releasable portion or other part of the base, and a tumbler attached to a releasable portion. The tumbler 134 is accessible external to the base by a key hole 116 to lock the one or more dispensing bottles into the base with a key, thereby preventing easy removal. In one case, turning the key rotates the tumbler 134 to hold the releasable portion. For example, the tumbler 134 can have a continuous channel with a deep portion that locks in the pin and narrows to a shallow portion that does not lock in the pin. One of ordinary skill in the art will recognize many variations. The tumbler 134 is preferably composed of a rigid material, such as steel, to withstand tampering. The keys can be general master keys for easy access by employees to all similar devices, or keys can be custom.

The holding pin 132 is attached to two sides of the base over a distance to give reasonable support, while additional length is possible for even more support in some implementations. In a different embodiment, the tumbler is attached to the non-releasable portion and the holding pin is attached to the releasable portion. In still another embodiment, a tumbler has a built-in holding pin that rotates with a key turn to lock when the lever is turned to a non-releasable portion and unlock when turned to a releasable portion. Regardless of the implementation, the holding pin 132 is designed to clear the flange portion 124 when rotated.

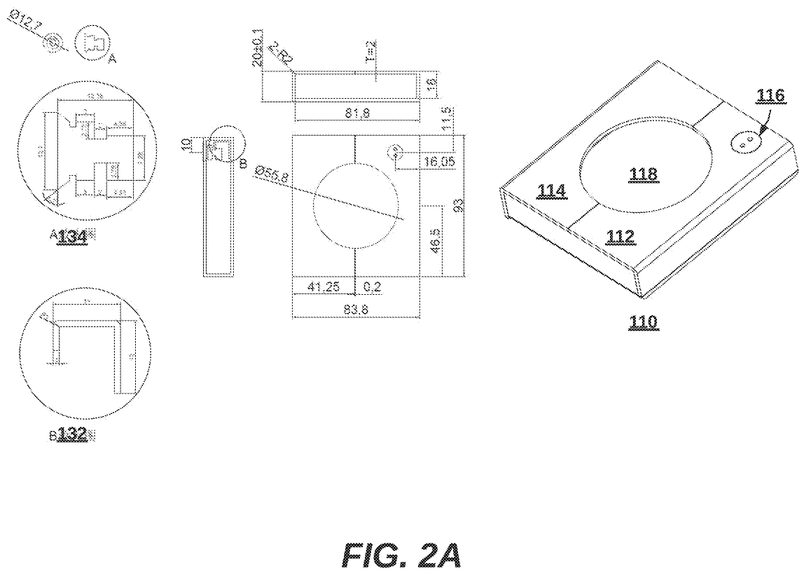

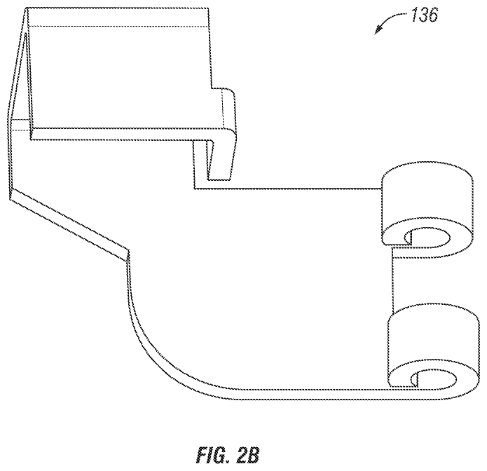

An alternative locking mechanism 136 is shown in FIG. 2B, according to an embodiment. This locking mechanism 136 includes an integral holding pin and hinge. A single cast has fewer welds and can be implemented more easily or less expensively. The additional surface area and hinge connection can also be stronger than other variations.

Sizing for components in the system 100 can be proportional to each other. For example, a base 110 should be sufficient in height to hold a limited size of dispensing bottles to provide proper support. Additionally, flanged portions 124 for dispensing bottles 120 should be thicker and wider for large bottles to prevent shearing and within range to fit in a base.

### II. Methods for Secured Toiletries Dispensing

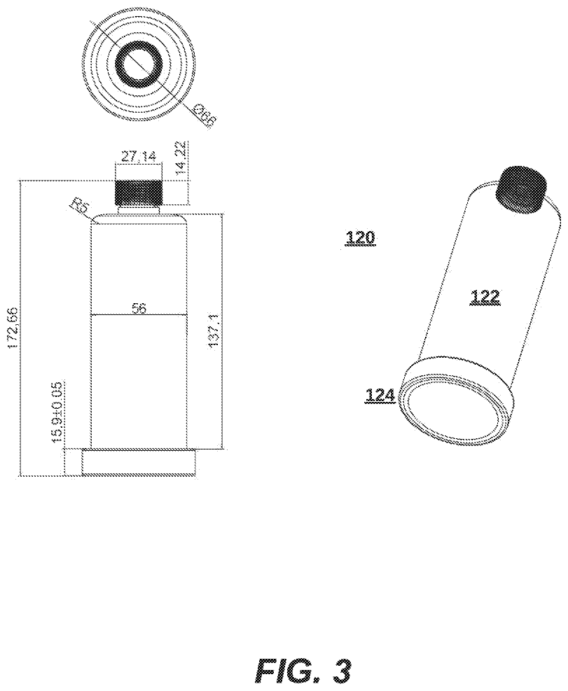

FIG. 3 is a high-level flow diagram of a method 300 for securing toiletries dispensing, according to an embodiment. The following steps are merely one example grouping functionalities that can be performed in different orders and can include more or less steps.

At step 310, a bottom plate of a base is mounted to a vanity top.

At step 320, one or more dispensing bottles including flanged bottoms is slid between the base bottom plate and a top plate of the base. The base top plate has one or more openings for the one or more dispensing bottles. The flanged bottoms have a diameter greater than the one or more openings of the base top plate. The one or more openings has a releasable portion and a non-releasable portion, the releasable portion accommodating the one or more flanged bottoms sliding between the base bottom plate and the base top plate.

At step 330, a tumbler attached to hold a releasable portion of a locking mechanism having a holding pin attached to a non-releasable portion and a tumbler attached to a releasable portion is rotated. The tumbler is accessible external to the base plate by a key to lock the one or more dispensing bottles into the base.

### III. Other Embodiments

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical access applications. This description will enable others skilled in the art to best utilize and practice the invention in various embodiments and with various modifications as are suited to a particular use. The scope of the invention is defined by the following claims.

1. A secured, toiletries dispensing device, the device comprising:
a base including a bottom plate configured for mounting to a surface, and a top plate;
one or more dispensing bottles including flanged bottoms, wherein the base top plate has one or more openings for the one or more dispensing bottles, the flanged bottoms have a diameter greater than the one or more openings of the base top plate, and the one or more openings has a releasable portion and a non-releasable portion, the releasable portion to accommodate the one or more flanged bottoms to slide between the base bottom plate and the base top plate; and
a locking mechanism having a holding pin and a tumbler, wherein the tumbler is accessible external to the base plate by a key to lock the one or more dispensing bottles into the base plate by rotating the tumbler to hold the releasable portion.

2. The toiletries dispensing device of claim 1, wherein the holding pin engages a slot of the tumbler, the slot having a first depth and a second depth greater than the first depth, and wherein the holding pin is disposed within the slot for locking the one or more bottles when rotated by the key to a first position and the holding pin is disposed outside of the slot for unlocking the one or more bottles when rotated by the key to a second position.

3. The toiletries dispensing device of claim 1, wherein the holding pin is attached to a non-releasable portion of the base and the tumbler is attached to a releasable portion of the base.

4. The toiletries dispensing device of claim 1, wherein the holding pin is attached to a releasable portion of the base and the tumbler is attached to a non-releasable portion of the base.

5. The toiletries dispensing device of claim 1, wherein the holding pin and the tumbler are attached to a releasable portion of the base and the holding pin is rotated to engage a non-releasable portion of the base.

6. The toiletries dispensing device of claim 1, wherein the base plate is composed of stainless steel.

7. The toiletries dispensing device of claim 1, wherein the releasable portion of the one or more openings of the base top plate includes at least one hinge.

8. The toiletries dispensing device of claim 1, wherein a base height between the base bottom plate and the base bottom plate is greater than a height of the one or more flanged bottoms of the one or more bottles.

9. The toiletries dispensing device of claim 1, wherein the surface that the base upon which the base is mounted is horizontal.

10. A method for securing a toiletries dispensing device, the method comprising:
mounting a bottom plate of a base to a surface;
sliding one or more dispensing bottles including flanged bottoms between the base bottom plate and a top plate of the base, wherein the base top plate has one or more openings for the one or more dispensing bottles, the flanged bottoms have a diameter greater than the one or more openings of the base top plate, and the one or more openings has a releasable portion and a non-releasable portion, the releasable portion to accommodate the one or more flanged bottoms sliding between the base bottom plate and the base top plate; and
rotating a tumbler attached to hold a releasable portion of a locking mechanism having a holding pin attached to a non-releasable portion and a tumbler attached to a releasable portion, wherein the tumbler is accessible external to the base plate by a key to lock the one or more dispensing bottles into the base plate.
